(19) United States
(12) Patent Application Publication
(10) Pub. No.: US 2021/0065744 A1
(43) Pub. Date: Mar. 4, 2021

(54) MAGNETIC DISK DEVICE AND METHOD OF CONTROLLING MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Shinya Ito, Fujisawa Kanagawa (JP)

(21) Appl. No.: 16/808,434

(22) Filed: Mar. 4, 2020

(30) Foreign Application Priority Data
Sep. 4, 2019 (JP) 2019-161450

(51) Int. Cl. G11B 20/12; G11B 5/39; G11B 27/10

(52) U.S. Cl. CPC G11B 20/1217; G11B 2005/0018; G11B 27/105; G11B 5/3967

(57) ABSTRACT

According to one embodiment, a controller of a magnetic disk device determines whether or not to cause a magnetic flux control unit to generate a magnetic field, and in accordance with the determination result, causes a control circuit to apply a drive voltage to the magnetic flux control unit so that an assisted recording area and a non-assisted recording area are provided in a magnetic disk mixedly as desired.

### CROSS-REFERENCE TO RELATED APPLICATIONS

This application is based upon and claims the benefit of priority from Japanese Patent Application No. 2019-161450, filed Sep. 4, 2019, the entire contents of which are incorporated herein by reference.

### FIELD

Embodiments described herein relate generally to a magnetic disk device and a method of controlling the magnetic disk device.

### BACKGROUND

As an example of a technique for increasing a recording density and a recording capacity of a magnetic disk device, high frequency assisted recording (MAMR: Microwave Assisted Magnetic Recording) is known. In the MAMR, a magnetic head having a recording magnetic pole (main magnetic pole) and a high-frequency oscillation element is used. The recording magnetic pole is excited by a recording current applied thereto and generates a recording magnetic field. The high-frequency oscillation element generates a high-frequency magnetic field when energized. The generated high-frequency magnetic field is applied to a disk and reduces a coercive force of a high-frequency magnetic field applied part of the disk. Accordingly, it is possible to perform high-density recording with a small narrow head.

However, it is known that a recording performance of the high-frequency oscillation element decreases with an increase of the length of application time of a drive voltage. The decrease in recording performance of the high-frequency oscillation element (element lifetime) over time has a considerable impact on the quality of the magnetic disk device.

It is an object of the embodiment of the present invention to provide a magnetic disk device capable of suppressing deterioration in quality due to a decrease in element lifetime and a method of controlling the magnetic disk device.

### BRIEF DESCRIPTION OF THE DRAWINGS

FIG. 1 is a diagram illustrating an example of a schematic configuration of a magnetic disk device according to an embodiment.

FIG. 2 is an enlarged cross-sectional view illustrating an example of a disk and a head of the magnetic disk device according to the embodiment.

FIG. 3 is a diagram illustrating an example of the state of recording surfaces of the disks in the magnetic disk device according to the embodiment, in which each surface is mixedly provided with an MAMR function ON area and a MAMR function OFF area.

FIG. 4 is a diagram illustrating an example of the state of the recording surfaces of the disks in the magnetic disk device according to the embodiment, in which disks having only the MAMR function ON area and a disk having only the MAMR function OFF area are mixedly provided.

FIG. 5 is a flowchart illustrating an example of a data writing process in the magnetic disk device according to the embodiment.

FIG. 6 is a flowchart illustrating an example of an assisted recording condition determination process (first determination process) in which a head lifetime in the magnetic disk device according to the embodiment is applied as a determination factor.

FIG. 7 is a flowchart illustrating an example of an assisted recording condition determination process (second determination process) in which validity of a media cache in the magnetic disk device according to the embodiment is applied as a determination factor.

FIG. 8 is a drawing illustrating an example of a recording image of an address table in the magnetic disk device according to the embodiment.

FIG. 9 is a flowchart illustrating an example of a zone replacement/movement process in the magnetic disk device according to the embodiment.

FIG. 10A is a diagram schematically illustrating a state before the zone replacement in the magnetic disk device according to the embodiment.

FIG. 10B is a diagram schematically illustrating a state after the zone replacement in the magnetic disk device according to the embodiment.

FIG. 11A is a diagram schematically illustrating a state before the zone movement in the magnetic disk device according to the embodiment.

FIG. 11B is a diagram schematically illustrating a state after the zone movement in the magnetic disk device according to the embodiment.

### DETAILED DESCRIPTION

In general, according to one embodiment, a magnetic disk device includes: a magnetic disk; a head having a magnetic flux control unit configured to generate a magnetic field toward the magnetic disk; a control circuit configured to apply a drive voltage for generating a magnetic field to the magnetic flux control unit; and a controller configured to control the head and the control circuit, respectively. The controller determines whether or not to cause the magnetic flux control unit to generate a magnetic field, and in accordance with the determination result, causes the control circuit to apply a drive voltage to the magnetic flux control unit so that an assisted recording area and a non-assisted recording area are provided in the magnetic disk mixedly as desired. The assisted recording area is an area of the magnetic disk in which data is written while a magnetic field is generated and the non-assisted recording area is an area of the magnetic disk in which data is written while a magnetic field is not generated.

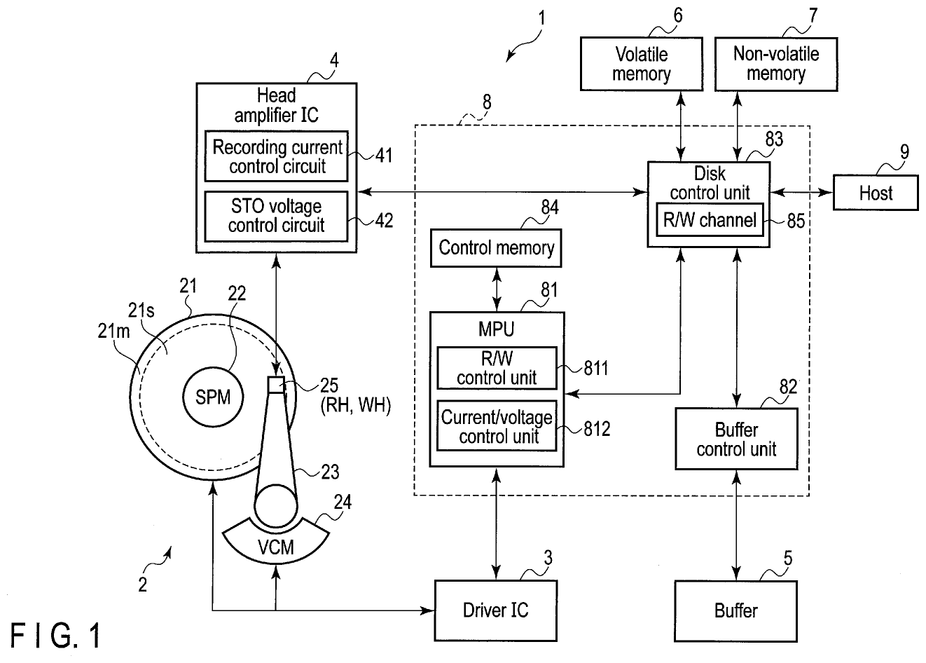

A magnetic disk device (hereinafter referred to as “HDD”) according to an embodiment will be described below with reference to FIGS. 1 to 11B.

FIG. 1 is a diagram illustrating an example of a schematic configuration of an HDD 1 according to the embodiment. As illustrated in FIG. 1, the HDD 1 includes a head disk assembly (hereinafter referred to as “HDA”) 2, a driver IC 3, a head amplifier integrated circuit (hereinafter referred to as “head amplifier IC”) 4, a buffer 5, a volatile memory 6, a non-volatile memory 7, and a system controller (controller) 8. The HDD 1 is connected to the host 9 so as to be communicable.

The HDA 2 includes a magnetic disk (hereinafter simply referred to as “disk”) 21, a spindle motor (hereinafter referred to as “SPM”) 22, an arm 23, and a voice coil motor (hereinafter referred to as “VCM”) 24.

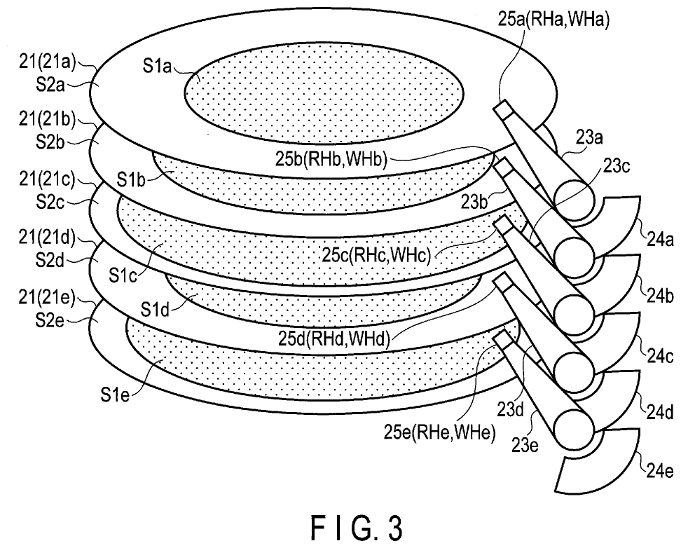

The disk 21 is a magnetic recording medium having a recording surface on which data is magnetically recorded. In the example illustrated in FIG. 1, one side is used as a recording surface, but the disk 21 may have recording surfaces on both sides. A recording area 21s usable by a user and a media cache 21m used as a cache for the recording area 21s are allocated to the recording surface of the disk 21. The media cache 21m is an area where the frequency of data writing (writing) is higher than that of the recording area 21s, and is disposed on the outer side of the recording area 21s, for example. The outer side of the disk 21 is a side relatively close to an outer peripheral edge in the radial direction, and an opposite side (side closer to the inner peripheral edge) corresponds to the inner side. The media cache may be disposed on the inner side of the recording area. The disk 21 rotates by being driven by the SPM 22. The SPM 22 is driven by power supplied from a power source (not illustrated) of the HDD 1 via the driver IC 3. The number of disks 21 is not particularly limited. As illustrated in FIG. 3, the HDD 1 includes five disks 21a to 21e, for example. FIG. 3 is a diagram illustrating an example of the state of recording surfaces of the disks 21a to 21e in the HDD 1 according to the embodiment, in which respective surfaces are mixedly provided with MAMR function ON areas S1a to S1e and MAMR function OFF areas S2a to S2e, which will be described later, respectively. In FIG. 3, for convenience, the five disks 21a to 21e are illustrated as being shifted, but these disks are arranged coaxially. Note that the number of disks 21 may be four or less, or six or more.

The arm 23 and the VCM 24 constitute an actuator. A head 25 is mounted on the arm 23. The VCM 24 is driven by an electric power supplied from the power source through the driver IC 3 and controls the arm 23 to move the head 25 to a target position on the disk 21. In the configuration example illustrated in FIG. 3, arms 23 (heads 25) and VCMs 24 are provided, the numbers of which are each five, according to the number (five) of the disks 21 (the arms 23a to 23e, the VCMs 24a to 24e, and the heads 25a to 25e).

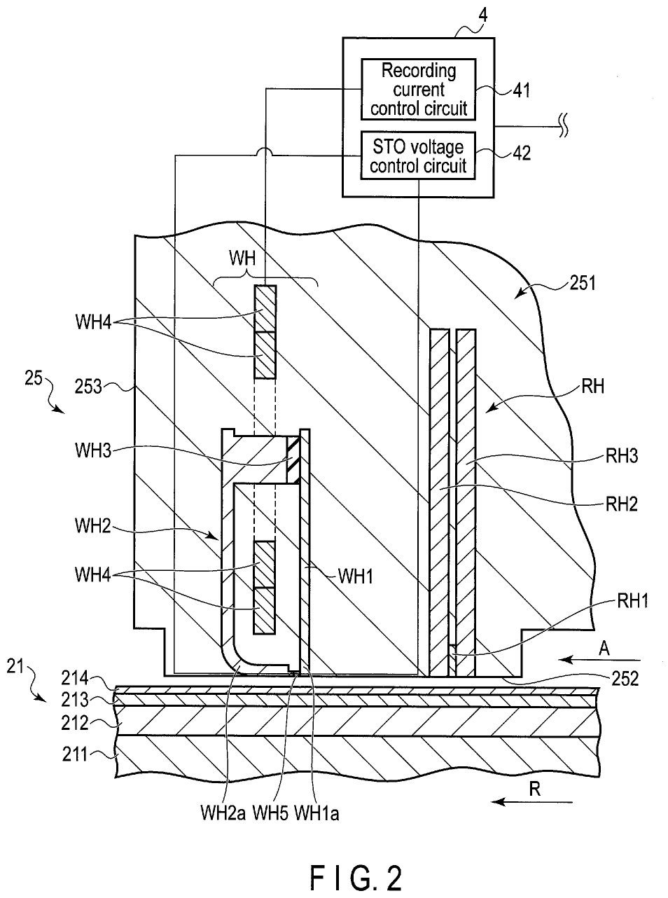

FIG. 2 is an enlarged cross-sectional view illustrating an example of the disk 21 and the head 25. The configurations of the disks 21a to 21e are the same. The configurations of the heads 25a to 25e are the same. In the configuration example illustrated in FIG. 2, the disk 21 is configured by laminating a substrate 211, a soft magnetic layer 212, a magnetic recording layer 213, and a protective film layer 214 from the bottom to the top. In FIG. 2, a direction from the head 25 toward the disk 21 is defined as down (lower side, downward), and a direction from the disk 21 to the head 25 is defined as up (upper side, upward). Further, a direction indicated by an arrow R is a direction of rotation of the disk 21, the direction indicated by the arrow A is a direction of a flow of air (air flow), and both directions are the same.

The substrate 211 is made of a disk-shaped non-magnetic material. The soft magnetic layer 212 is made of a material having soft magnetic characteristics and formed on the substrate 21. The magnetic recording layer 213 is formed on the soft magnetic layer 212 and has magnetic anisotropy in a direction perpendicular to a surface of the disk 21 (the surface of the magnetic recording layer 213 or the surface of the protective film layer 214). The protective film layer 214 is formed on the magnetic recording layer 213.

The head 25 includes a slider 251 which is a main body, and a read head RH and a write head WH both mounted on the slider 251. The read head RH reads data recorded on a data track on the disk 21. The write head WH writes data on the disk 21. The head 25 writes data on the disk 21 in units of blocks including at least one sector, and reads data from the disk 21 in units of blocks. The track is defined as a continuous area in the circumferential direction of the disk 21 and includes a plurality of sectors. One sector is defined as a segment of an area obtained by dividing the track into a plurality of parts in the circumferential direction, and is a minimum unit of read data or write data for the disk 21.

The slider 251 is made of, for example, a sintered body (AlTic) of alumina and titanium carbide. The slider 251 has a disk facing surface (air bearing surface (ABS)) 252 facing the surface of the disk 21 and a trailing end 253 located on an outflow side of the air flow direction A. Parts of the read head RH and the write head WH are exposed from a disk facing surface 252 and faces the surface of the disk 21.

The read head RH includes a magnetic film RH1, a shield film RH2, and a shield film RH3. The magnetic film RH1 is located between the shield film RH2 and the shield film RH3 and produces a magnetoresistance effect. The shield film RH2 is located on the trailing end 253 side with respect to the magnetic film RH1. The shield film RH3 is located opposite to the shield film RH2 with respect to the magnetic film RH1, and faces the shield film RH2 with the magnetic film RH1 interposed therebetween. Lower ends of the magnetic film RH1, the shield film RH2, and the shield film RH3 are exposed from a disk facing surface 252 and face the surface of the disk 21.

The write head WH is provided on the trailing end 253 side of the slider 251 with respect to the read head RH. The write head WH includes a main magnetic pole WH1, a trailing shield (write shield) WH2, an insulator WH3, a recording coil WH4, and a magnetic flux control unit WH5.

The main magnetic pole WH1 is made of a soft magnetic material having a high saturation magnetic flux density. The main magnetic pole WH1 generates a recording magnetic field perpendicular to the surface of the disk 21 in order to magnetize the magnetic recording layer 213 of the disk 21. In the example illustrated in FIG. 2, the main magnetic pole WH1 stands substantially perpendicular to the disk facing surface 252 (the surface of the disk 21). A lower surface of a distal end portion WH1a of the main magnetic pole WH1 is exposed from the disk facing surface 252 and faces the surface of the disk 21. The distal end portion WH1a of the main magnetic pole WH1 is narrowed toward the surface of the disk 21, and is formed in a columnar shape that is narrower than the other parts. The width in the cross track direction of the distal end portion WH1a of the main magnetic pole WH1 substantially corresponds to the track width of the write track. The cross track direction is, for example, a direction along the radial direction.

The write shield WH2 is made of a soft magnetic material having a high saturation magnetic flux density. The write shield WH2 is provided to efficiently close a magnetic path via the soft magnetic layer 212 right below the main magnetic pole WH1. The write shield WH2 is located on the trailing end 253 side with respect to the main magnetic pole WH1, and is connected to the main magnetic pole WH1 via the insulator WH3. The main magnetic pole WH1 and the write shield WH2 are electrically insulated and form a magnetic circuit. The write shield WH2 stands up to face the main magnetic pole WH1 and has a shape bent along the disk facing surface 252 (the surface of the disk 21). A distal end portion WH2a on the disk facing surface 252 side is opposed to the distal end portion WH1a of the main magnetic pole WH1 with a write gap formed therebetween. A lower surface of the distal end portion WH2a is exposed from the disk facing surface 252 and faces the surface of the disk 21.

The recording coil WH4 is provided so as to be wound around the magnetic circuit including the main magnetic pole WH1 and the write shield WH2 so that a magnetic flux flows through the main magnetic pole WH1. The recording coil WH4 is wound, for example, between the main magnetic pole WH1 and the write shield WH2. By supplying a current of a predetermined magnitude (hereinafter referred to as “recording current”) to the recording coil WH4, a recording magnetic field is excited in the main magnetic pole WH1 and the write shield WH2. As a result, the main magnetic pole WH1 and the write shield WH2 are magnetized. The magnetization direction of the recording bit of the magnetic recording layer 213 of the disk 21 is changed by the magnetic flux flowing through the magnetized main magnetic pole WH1 and the write shield WH2. Accordingly, a magnetization pattern corresponding to the recording current is recorded on the disk 21.

The magnetic flux control unit WH5 is a high-frequency oscillation element, for example, a spin torque oscillator (STO) (hereinafter referred to as “spin torque oscillator WH5”). The spin torque oscillator WH5 is provided between the distal end portion WH1a of the main magnetic pole WH1 and the distal end portion WH2a of the write shield WH2 (hereinafter referred to as “write gap”). The spin torque oscillator WH5 includes, for example, an underlayer made of a non-magnetic conductive layer, a spin injection layer, an intermediate layer, an oscillation layer, and a gap layer made of a nonmagnetic conductive layer laminated from the distal end portion WH1a side of the main magnetic pole WH1 to the distal end portion WH2a side of the write shield WH2 in the presented order.

In the spin torque oscillator WH5, when a drive voltage of a predetermined magnitude is applied, the magnetization is uniformly rotated by a gap magnetic field generated in the write gap (spin precession motion), and the high-frequency magnetic field (microwave) is generated toward the disk 21. The frequency of the microwave is sufficiently higher than the frequency of the recording signal. The spin torque oscillator WH5 reduces the coercive force of the magnetic recording layer 213 by applying a high-frequency magnetic field to the magnetic recording layer 213 of the disk 21. When the spin torque oscillator WH5 generates a large amount of spin precession motion, the permeability of the spin torque oscillator WH5 is as low as that of air. Therefore, the magnetic flux from the main magnetic pole WH1 flows more easily toward the disk 21 than toward the write gap (spin torque oscillator WH5). Accordingly, the spin torque oscillator WH5 assists in writing data to the disk 21. In contrast, when the spin precession motion is not generated in the spin torque oscillator WH5 or is generated by an amount less than usual, the permeability of the spin torque oscillator WH5 is higher than the permeability of air. Therefore, the magnetic flux from the main magnetic pole WH1 is more likely to flow toward the write gap (spin torque oscillator WH5) than toward the disk 21.

In the following description, a writing process in which a drive voltage is applied to the spin torque oscillator WH5 to write data on the disk 21 while a high-frequency magnetic field is generated is referred to as “assisted recording”. Further, the drive voltage when the assisted recording is executed is referred to as “assist voltage”. In the assisted recording, data can be written with a narrower track pitch, and the recording density can be increased, compared with a writing process in which data is written without applying an assist voltage to the spin torque oscillator WH5. In contrast to the assisted recording, a writing process in which data is written without applying an assist voltage to the spin torque oscillator WH5 and without generating a high-frequency magnetic field is referred to as “non-assisted recording”. Note that it is also possible to provide the assist voltage with a width. For example, it is also possible to execute the assisted recording by selecting and applying a drive voltage such as a maximum value of the assist voltage, or 70%, 50%, 30% or the like of the maximum value. In other words, the assisted recording may include an arbitrary writing process for writing data by applying an assist voltage within a predetermined range.

The head 25 having such a configuration is provided on each of the five arms 23a to 23e. Each head 25a to 25e is tested for its operating performance, for example, the element lifetime of the spin torque oscillator WH5, before being incorporated into the HDD 1. The operation performance of the head 25 (hereinafter referred to as “head lifetime”) is not uniform, and there is superiority or inferiority among, for example, the five heads 25a to 25e.

The driver IC 3 controls the driving of the SPM 22 and the VCM 24 (24a to 24e) according to the control of the system controller 8 (more specifically, MPU 81 described later).

The head amplifier IC (preamplifier) 4 includes a read amplifier and a write driver (not illustrated). The read amplifier amplifies the read signal read from the disk 21 and outputs it to the system controller 8 (specifically, a read/write (R/W) channel 85 described later). The write driver in the head amplifier IC (preamplifier) 4 is an element configured to output a recording current corresponding to write data output from an R/W channel 85 to the head 25, and includes, for example, a recording current control circuit 41 and an STO voltage control circuit 42.

The recording current control circuit 41 is electrically connected to the recording coil WH4 and supplies a recording current corresponding to the write data output from the R/W channel 85 to the recording coil WH4. For example, the recording current control circuit 41 supplies a recording current to the recording coil WH4 under the control of the system controller 8 (MPU 81).

The STO voltage control circuit 42 is electrically connected to the spin torque oscillator WH5, and applies a predetermined assist voltage to the spin torque oscillator WH5 under the control of the system controller 8 (MPU 81), for example. In other words, the STO voltage control circuit 42 is a control circuit configured to apply a drive voltage (assist voltage) that generates a high-frequency magnetic field to the spin torque oscillator WH5, which is a magnetic flux control unit.

The buffer 5 is a semiconductor memory configured to temporarily record data transmitted and received between the HDD 1 and the host 9. Examples of the buffer 5 include Dynamic Random Access Memory (DRAM), Static Random Access Memory (SRAM), Synchronous Dynamic Random Access Memory (SDRAM), Ferroelectric Random Access Memory (FeRAM), and Magneto resistive Random Access Memory (MRAM).

The volatile memory 6 is a semiconductor memory in which the stored data is lost when power supply is cut off. The volatile memory 6 stores data necessary for processing in each unit of the HDD 1. The volatile memory 6 is, for example, DRAM or SDRAM.

The non-volatile memory 7 is a semiconductor memory in which the stored data is recorded even when power supply is cut off. Examples of the non-volatile memory 7 include an NOR type and NAND type flash ROM (Flash Read Only Memory: FROM). In the storage area of the non-volatile memory 7, an initial program loader (IPL) is stored in advance. The MPU 81 to be described later loads at least a part of a control program stored in the disk 21 to a control memory 84 to be described later by executing IPL when the power source is turned on, for example.

The system controller 8 is realized by using, for example, a large-scale integrated circuit (LSI) called a System-on-a-Chip (SoC) in which a plurality of elements are integrated on a single chip. The system controller 8 includes the MPU 81, a buffer control unit 82, a disk control unit 83, and a control memory 84, respectively. The system controller 8 is electrically connected to the driver IC 3, the head amplifier IC 4, the buffer 5, the volatile memory 6, the non-volatile memory 7, and the host 9.

The MPU 81 is a main controller configured to control each part of the HDD 1. When the power source is turned on, the MPU 81 executes the IPL of the non-volatile memory 7 and loads the control program stored in the disk 21 into the control memory 84. Accordingly, the MPU 81 executes a process for operating the system controller 8 in a predetermined operation mode. The MPU 81 is connected to the driver IC 3, the disk control unit 83 (specifically, the R/W channel 85 described later), and the control memory 84.

The MPU 81 includes a read/write (R/W) control unit 811 and a current/voltage control unit 812. The MPU 81 executes processing in the R/W control unit 811 and the current/voltage control unit 812 on the firmware. Note that the MPU 81 may include the R/W control unit 811 and the current/voltage control unit 812 as a circuit.

The R/W control unit 811 controls a data reading process and a data writing process in accordance with commands from the host 9. For example, the R/W control unit 811 controls a rotation speed of the SPM 22 via the driver IC 3 and also executes servo control for controlling the VCM 24 and positioning the head 25. During the data reading process, the R/W control unit 811 controls the data read operation from the disk 21 and controls the process of read data. At the time of data writing process, the R/W control unit 811 controls the data writing operation to the disk 21 and selects a storage destination of the write data transferred from the host 9.

In addition, the R/W control unit 811 determines assisted recording conditions described later. In determining the assisted recording conditions, the R/W control unit 811 detects the head lifetime of the head 25, for example, and compares the detected lifetime with a reference lifetime described later. The R/W control unit 811 also determines whether or not the write data storage destination is the media cache 21m. Then, in accordance with a determination result of the assisted recording conditions, the R/W control unit 811 executes control for writing the write data via the assisted recording or the non-assisted recording.

The current/voltage control unit 812 receives an instruction from the R/W control unit 811 and controls the current and the voltage supplied from the power source. For example, the current/voltage control unit 812 controls the head amplifier IC 4 (the recording current control circuit 41 and the STO voltage control circuit 42), and controls (adjusts) the recording current and the assist voltage for the head 25. Accordingly, in the write head WH, a recording current supplied from the recording current control circuit 41 to the recording coil WH4 is controlled. Further, an assist voltage applied from the STO voltage control circuit 42 to the spin torque oscillator WH5 is controlled.

The buffer control unit 82 controls data exchange between the buffer 5 and the system controller 8. The buffer control unit 82 is connected to the buffer 5 and the disk control unit 83.

The disk control unit 83 has a read/write (R/W) channel 85 and controls data transfer between the host 9 and the R/W channel 85 in accordance with an instruction from the MPU 81. The disk control unit 83 is connected to the buffer 5, the volatile memory 6, the non-volatile memory 7, the host 9, the MPU 81, and the buffer control unit 82.

The R/W channel 85 executes a signal process of read data and write data in response to an instruction from the MPU 81. The R/W channel 85 has a circuit or a function for measuring a signal quality of read data. For example, the R/W channel 85 has a function of executing error correction processing (Error Checking and Correcting: ECC) on read data read from the disk 21. The R/W channel 85 is connected to the head amplifier IC 4 and MPU 81.

The control memory 84 is a volatile memory such as a DRAM. A part of the control program is loaded into the storage area of the control memory 84. A part of the storage area of the control memory 84 is used as a command buffer. The command buffer stores a queue of read commands and write commands received from the host 9. The control memory 84 is connected to the MPU 81.

When reading and writing data from/to the disk 21, the system controller 8 operates as follows. When the read command is received from the host 9, the MPU 81 stores read data in the buffer 5 via the head amplifier IC 4, the disk control unit 83, and the buffer control unit 82. Then, the MPU 81 controls to transmit the read data stored in the buffer 5 to the host 9. Upon reception of a write command (write data) from the host 9, the system controller 8 stores the write data in the buffer 5 via the buffer control unit 82. The MPU 81 writes the write data to the disk 21 via the buffer control unit 82, the disk control unit 83, and the head amplifier IC 4.

In the embodiment, the system controller 8 appropriately switches the mode of control between control to execute the assisted recording and control not to execute the assisted recording when data is written to the disk 21. When executing the assisted recording, the MPU 81 applies an assist voltage to the spin torque oscillator WH5 to cause the write head WH to write data. In contrast, when the assisted recording is not executed and the non-assisted recording is executed, the MPU 81 causes the write head WH to write data without applying an assist voltage to the spin torque oscillator WH5.

Accordingly, an area where data is to be written via the assisted recording, that is, an area where the data is written in an assisted manner (hereinafter referred to as “MAMR function ON area”), and an area where data is written via the non-assisted recording, that is, an area where the data is written without assistance (hereinafter referred to as “MAMR function OFF area”) can be mixedly provided on the recording surface of one disk 21. Therefore, on each recording surface of the plurality of disks 21, the MAMR function ON area, which is the assisted recording area, and the MAMR function OFF area, which is the non-assisted recording area, can be mixedly provided. FIG. 3 illustrates an example of the state of the recording surfaces of the disks 21a to 21e in which the MAMR function ON areas S1a to S1e and the MAMR function OFF areas S2a to S2e are mixedly provided, respectively. Note that FIG. 3 illustrates an example in which the MAMR function ON areas S1a to S1e and the MAMR function OFF areas S2a to S2e each are present at one position (in a form of continuous track areas), but these areas may be present in a plurality of positions.

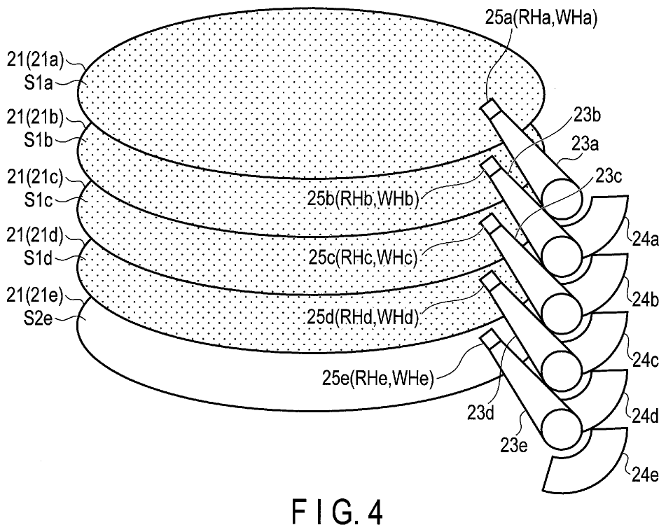

In this manner, the system controller 8 can appropriately switch the mode of control between the control to execute the assisted recording and the control not to execute the assisted recording (non-assisted recording) when writing data to the disk 21, so that each recording surface of the plurality of disks 21 may be provided with only one of the MAMR function ON area and the MAMR function OFF area. In other word, a plurality of disks 21 may mixedly include the disk 21 having only the MAMR function ON area and the disk 21 having only the MAMR function OFF area. FIG. 4 illustrates an example of a state of the recording surfaces of the disks 21a to 21e mixedly including the disks 21a to 21d having only the MAMR function ON areas S1a to S1d and the disk 21e having only the MAMR function OFF area S2e.

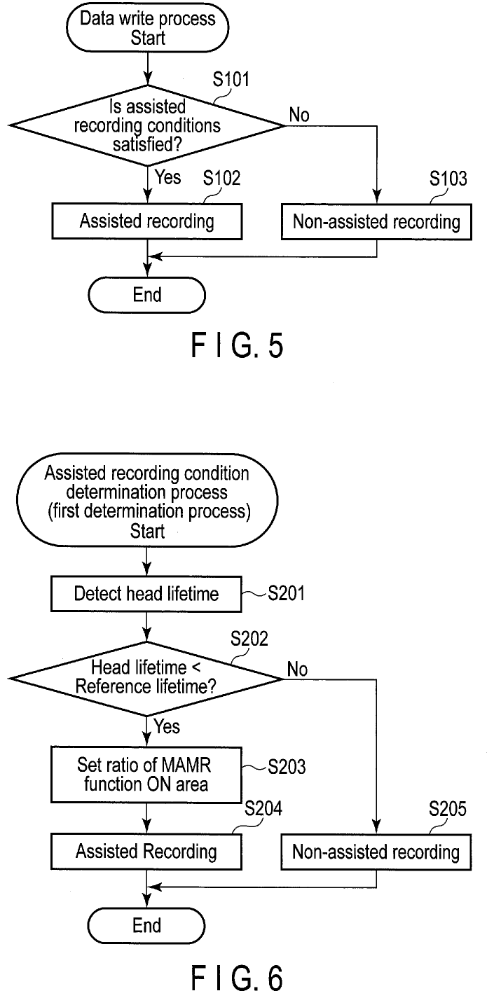

Next, a data writing process for mixedly providing the MAMR function ON area and the MAMR function OFF area in this manner will be described with reference to a flowchart. FIG. 5 is a flowchart illustrating an example of a data writing process.

As illustrated in FIG. 5, in the writing process, the MPU 81, specifically, the R/W control unit 811 determines assisted recording conditions (S101). The assisted recording conditions are conditions for determining whether or not write data is to be written via the assisted recording, that is, whether or not to assist writing of data by applying an assist voltage to the spin torque oscillator WH5. If the assisted recording conditions are satisfied, the write data is written via the assisted recording, and the recording surface of the disk 21 on which the write data is recorded becomes the MAMR function ON area. In contrast, if the assisted recording conditions are not satisfied, the write data is written via the non-assisted recording, and the recording surface of the disk 21 on which the write data is recorded becomes the MAMR function OFF area. Specific contents of the assisted recording conditions will be described later.

If the assisted recording conditions are satisfied in S101, the write data is written via the assisted recording (S102). Therefore, the current/voltage control unit 812 receives an instruction from the R/W control unit 811 and controls the recording current control circuit 41 of the head amplifier IC 4 to apply a recording current to the recording coil WH4. The current/voltage control unit 812 controls the STO voltage control circuit 42 of the head amplifier IC 4 to apply an assist voltage to the spin torque oscillator WH5. Accordingly, the R/W control unit 811 causes the write head WH to write (assisted recording) the write data to the disk 21 in a state in which a high-frequency magnetic field (microwave) is applied from the spin torque oscillator WH5 to the disk 21.

In contrast, if the assisted recording conditions are not satisfied in S101, the data is written via the non-assisted recording (S103). Therefore, the current/voltage control unit 812 controls the recording current control circuit 41 of the head amplifier IC 4 to apply a recording current to the recording coil WH4. In contrast, the current/voltage control unit 812 does not execute the control to apply an assist voltage to the spin torque oscillator WH5. Accordingly, the R/W control unit 811 causes the write head WH to write (non-assisted recording) the write data to the disk 21 in a state in which a high-frequency magnetic field (microwave) is not applied from the spin torque oscillator WH5 to the disk 21.

In this manner, if the assisted recording conditions are satisfied, the assisted recording is executed, and the MAMR function ON area is generated on the recording surface of the disk 21. In contrast, if the assisted recording conditions are not satisfied, non-assisted recording is executed, and the MAMR function OFF area is generated on the recording surface of the disk 21.

The specific contents (determination factors) of the assisted recording conditions can be applied as desired. For example, the ratio of the MAMR function ON area and the MAMR function OFF area on the recording surface of the disk 21 may be set in advance according to the head lifetime of the head 25, and the success or failure of the assisted recording conditions may be determined based on the ratio. As an example, the ratio of the MAMR function OFF area may be increased with a decrease in the head lifetime of the head 25. Accordingly, since the head 25 having a shorter head lifetime has a smaller MAMR function OFF area, the application time of the assist voltage to the spin torque oscillator WH5 can be reduced, and thus the actual head lifetime can be extended compared to the test. As a result, the lifetime of the entire head 25, that is, the HDD 1 itself (device lifetime) can be extended to the lifetime equivalent to that of the head 25 having the longest head lifetime.

For example, in the configuration example illustrated in FIG. 3, the head lifetime of the head 25a is the shortest, and subsequently, is increased in the head 25d, the head 25b, and the head 25e in the presented order, and is the longest in the head 25c. Therefore, the ratio of the MAMR function OFF area in the disk 21 is the highest in the disk 21a, and subsequently, is decreased in the disk 21d, the disk 21b, and the disk 21e in the presented order, and is the lowest in the disk 21c. Note that the head lifetime is predicted by, for example, an operation performance test of the head 25 before being incorporated into the HDD 1. Therefore, the ratios of the MAMR function ON areas S1a to S1e and the MAMR function OFF areas S2a to S2e in the respective disks 21a to 21e are set in advance in accordance with the head lifetimes of the corresponding heads 25a to 25e. However, after the incorporation of the heads into HDD 1, for example, the ratios of MAMR function ON areas S1a to S1e and MAMR function OFF areas S2a to S2e on the recording surfaces of the respective disks 21a to 21e may be varied corresponding to the dynamic head lifetime after shipment.

Further, for example, according to the configuration example illustrated in FIG. 4, the ratio of the MAMR function OFF area is set to zero (0%), and only the MAMR function ON areas S1a to S1d are generated in the disks 21a to 21d. In the disk 21e, the ratio of the MAMR function OFF area S2e is set to 100%, and thus only the MAMR function OFF area S2e is generated. In other words, whether to execute the assisted recording or the non-assisted recording on the disks 21a to 21e is determined in advance depending on the mode of the heads 25a to 25e. In other words, the heads 25a to 25d execute only the assisted recording, and the head 25e executes only the non-assisted recording. In this case, in the same manner as in the configuration example illustrated in FIG. 3, the head lifetime can be applied as a determination factor for the assisted recording conditions.

FIG. 6 is a flowchart illustrating an example of an assisted recording condition determination process (first determination process) in which the head lifetime is applied as a determination factor. In such a determination process, the R/W control unit 811 detects the head lifetime of each head 25 (S201). For example, the R/W control unit 811 detects, for each head 25, an estimated value acquired by an operation performance test or the like of the head 25 before being incorporated into the HDD 1 as an index indicating the head lifetime. Instead, the R/W control unit 811 may dynamically detect an accumulated write amount and an accumulated write time of the write data for each head 25 as an index indicating the head lifetime.

Next, the R/W control unit 811 compares the detected head lifetime of each head 25 with a predetermined threshold value (hereinafter referred to as “reference lifetime”) (S202). The reference lifetime is, for example, an appropriate value of the head lifetime that is assumed when the head 25 reads read data and writes write data while appropriately switching the mode between the assisted recording and the non-assisted recording.

As a result of the comparison, for example, when the detected head lifetime has not reached the reference lifetime, the R/W control unit 811 determines that the assisted recording conditions are satisfied for the head 25 whose head lifetime has not reached the reference lifetime. In this case, the R/W control unit 811 sets the ratio of the MAMR function ON area that is written via the assisted recording by the head 25 (in other words, the ratio of the MAMR function OFF area) in accordance with the head lifetime (S203). For example, in the configuration example illustrated in FIG. 3, the ratio of the MAMR function OFF area is varied in accordance with the head lifetime. In the configuration example illustrated in FIG. 4, the ratio of the MAMR function OFF area is set to zero (0%).

When the ratio of the MAMR function ON area is set, the R/W control unit 811 executes the assisted recording with the head 25 (S204). When the assisted recording is executed, an assist voltage is applied from the STO voltage control circuit 42 to the spin torque oscillator WH5. Accordingly, the R/W control unit 811 causes the write head WH to write the write data to the disk 21 in a state in which a high-frequency magnetic field (microwave) is applied from the spin torque oscillator WH5 to the disk 21.

In contrast, when the detected head lifetime has reached the reference lifetime, the R/W control unit 811 determines that the assisted recording conditions are not satisfied for the head 25 whose head lifetime has reached the reference lifetime. In this case, the head 25 executes the non-assisted recording (S205). When the non-assisted recording is executed, no assist voltage is applied from the STO voltage control circuit 42 to the spin torque oscillator WH5. Accordingly, the R/W control unit 811 causes the write head WH to write the write data to the disk 21 without applying a high-frequency magnetic field (microwave) to the disk 21 from the spin torque oscillator WH5.

When the assisted recording conditions are determined in accordance with the head lifetime in this manner, for example, in the configuration example illustrated in FIG. 4, the head lifetimes of the heads 25a to 25d do not have reached the reference lifetime, and thus the heads 25a to 25d are used as assisted recording heads. In contrast, the head lifetime of the head 25e has reached the reference lifetime, and thus the head 25e is used as a non-assisted recording head. The reference lifetime can be set as desired. For example, the head 25 with the shortest head lifetime (for example, the head 25e) may be used as the non-assisted recording head, and the other heads 25 (for example, the heads 25a to 25d) may be used as the assisted recording heads.

In the embodiment, a media cache 21m is allocated to the recording surface of the disk 21. A data writing process is frequently executed on the media cache 21m. Therefore, whether or not the assisted recording conditions are satisfied may be determined based on whether or not it is the media cache 21m.

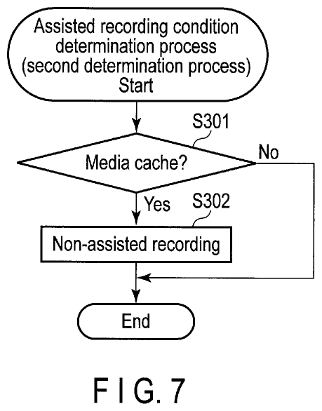

FIG. 7 is a flowchart illustrating an example of an assisted recording condition determination process (second determination process) in which whether or not the media cache 21m is successful is applied as a determination factor. In this determination process, the R/W control unit 811 determines whether the storage destination of the write data is the media cache 21m (S301). When the storage destination of the write data is the media cache 21m, the R/W control unit 811 determines that the assisted recording conditions are not satisfied. In this case, the write data is written via the non-assisted recording in the media cache 21m (S302). In other words, the media cache 21m becomes the MAMR function OFF area. By setting the media cache 21m to the MAMR function OFF area, the application time of the assist voltage to the spin torque oscillator WH5 may be reduced correspondingly. Accordingly, it is possible to extend the head lifetime, and thus the lifetime of the HDD 1.

Note that if the storage destination of the write data is not the media cache 21m, the R/W control unit 811 may determine that the assisted recording conditions are satisfied, or may continue to determine other assisted recording conditions. For example, when it is determined that the assisted recording conditions are satisfied, the write data is written via the assisted recording in the recording area 21s other than the media cache 21m. When other assisted recording conditions are determined, the R/W control unit 811 causes the write data to be written via the assisted recording or via the non-assisted recording in accordance with the determination result. In this case, for example, the first determination process described above may be performed, and the write data may be written via the assisted recording or via the non-assisted recording in accordance with the head lifetime.

As described above, according to the embodiment, when data is written to the disk 21, it is possible to appropriately switch the mode of control between the control to execute the assisted recording and the control not to execute the assisted recording (non-assisted recording). Such switching may be performed by determining the assisted recording conditions for each zone in which the head 25 writes data (hereinafter referred to as “head zone”). The head zone is a recording area including one or a plurality of tracks. At that time, for example, based on the write amount (writing amount) for each head zone, the head zone in the MAMR function ON area may be replaced with the head zone in the MAMR function OFF area between different disks 21 or may be moved within the same disk 21.

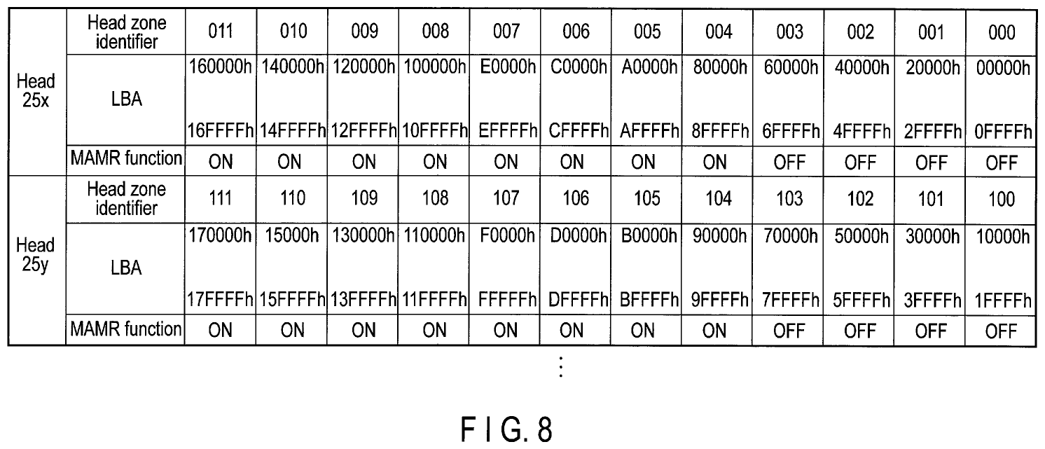

These replacement of the head zone (hereinafter referred to as “zone replacement”) and movement (hereinafter referred to as “zone movement”) are executed by updating information in the address table of the disk 21. FIG. 8 illustrates an example of a recording image of an address table. The address table includes physical addresses (real addresses) assigned to the head zones of the disk 21, the logical addresses (virtual addresses) uniquely allocated to the physical addresses, and correspondence indicating whether the head zone in question is the MAMR function ON area or the MAMR function OFF area. A unique identifier (corresponding to a physical address) is assigned to each head zone. The logical address (LBA) is allocated to a head zone (used area) where data is written, and is not allocated to a head zone (unused area) in which data is not written. The address table is stored in, for example, the non-volatile memory 7, and is read out by the R/W control unit 811 when the assisted recording conditions are determined. The update of table information for the zone replacement and the zone movement may be executed by a background process during periods between data write commands, for example. Accordingly, the rewriting of the table information is executed out of the control target of the host 9.

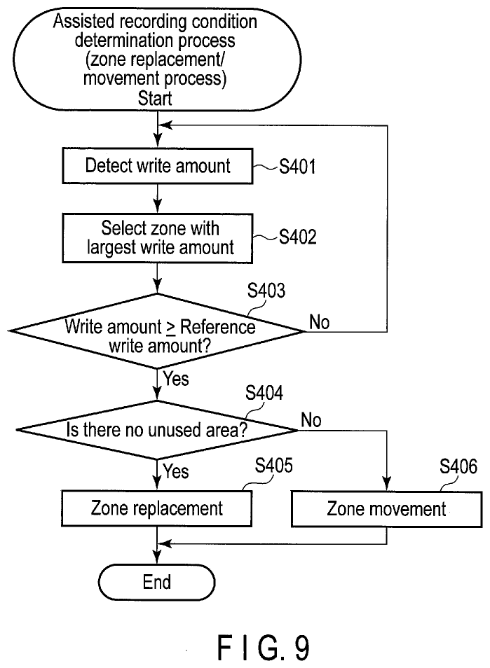

FIG. 9 is a flowchart illustrating an example of the zone replacement and the zone movement (zone replacement/movement) process. In the zone replacement/movement process, the R/W control unit 811 detects a write amount for each head zone by the head 25 (S401). For example, the R/W control unit 811 detects, for each head zone, the number of sectors of write data in which each head 25 has written via the assisted recording or via the non-assisted recording within a predetermined time.

Next, the R/W control unit 811 selects a head zone with the largest write amount based on the detected write amount via the assisted recording for each head zone (S402). The selected head zone is subjected to the zone replacement or the zone movement.

Subsequently, the R/W control unit 811 determines a write amount condition based on the write amount via the assisted recording in the selected head zone (S403). The write amount condition is a determination condition as to whether or not the write amount in assisted recording in the head zone is equal to or greater than a predetermined threshold value (hereinafter referred to as “reference write amount”). In determining the write amount condition, the R/W control unit 811 compares the write amount via the assisted recording of the selected head zone with the reference write amount. The reference write amount is, for example, the write amount of write data that is assumed to deteriorate the head lifetime if the write data is continuously written via the assisted recording.

For example, when the detected write amount is less than the reference write amount as a result of the comparison, the R/W control unit 811 detects the write amount achieved by the head 25 for each head zone (S401) again and selects a head zone with the largest write amount (S402), and then repeats a series of control for determining the write amount conditions.

In contrast, when the detected write amount is equal to or greater than the reference write amount for example, the R/W control unit 811 determines the presence or absence of a head zone (unused area) in which data is not written (S404). In the determination, the R/W control unit 811 determines, for example, the presence or absence of a head zone in which no logical address is allocated in the record of the disk 21 (head 25) corresponding to the selected head zone in the address table. The R/W control unit 811 executes the zone replacement when there is no unused area and the zone movement when there is an unused area, respectively, as follows. However, it is not excluded that the zone replacement is performed when there is an unused area.

When there is no unused area, the R/W control unit 811 performs the zone replacement for a head zone (hereinafter referred to as “replacement source zone”) in which the write amount via the assisted recording is equal to or greater than the reference write amount (has reached the reference write amount) (S405). For example, the R/W control unit 811 selects a head zone in which the write amount of data recorded by each head 25 in non-assisted manner performs the non-assisted recording within a predetermined time is the smallest (hereinafter referred to as “replacement destination zone”). Then, the replacement source zone is replaced with the MAMR function OFF area, and the selected replacement destination zone is replaced with the MAMR function ON area. Specifically, the R/W control unit 811 replaces the logical address of the replacement source zone and the logical address of the replacement destination zone in the address table, and updates the table information. Accordingly, the logical address allocated to the physical address of the replacement source zone is updated to the logical address allocated to the physical address of the replacement destination zone. In addition, the logical address allocated to the physical address of the replacement destination zone is updated to the logical address allocated to the physical address of the replacement source zone. Therefore, the write data of the replacement source zone is moved from the MAMR function ON area to the MAMR function OFF area on the logical address. Also, the write data of the replacement destination zone is moved from the MAMR function OFF area to the MAMR function ON area on the logical address.

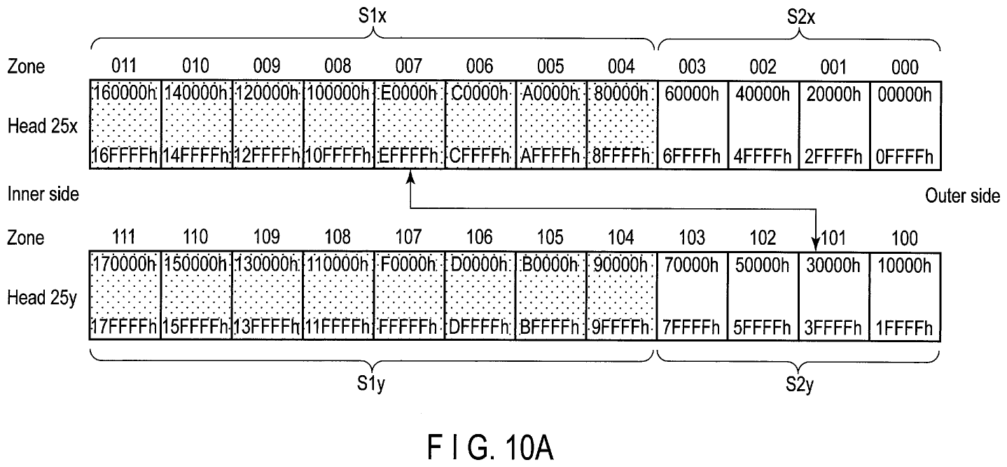

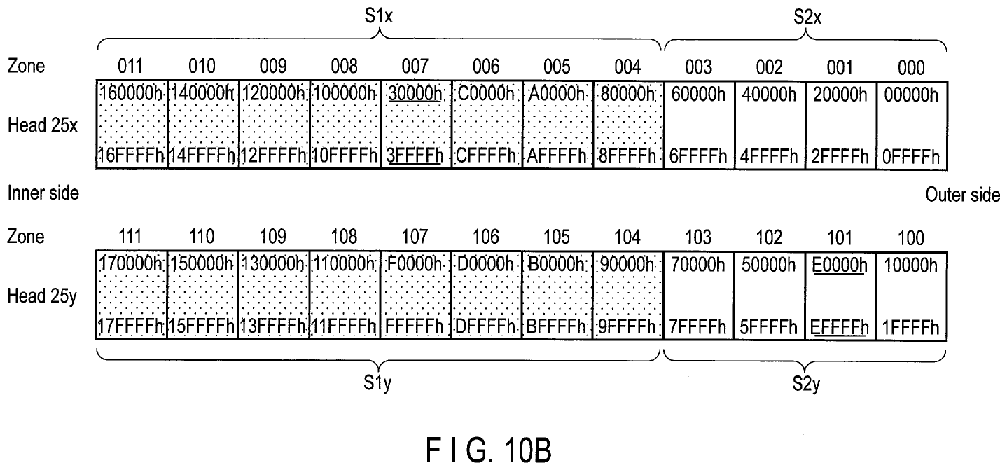

FIGS. 10A and 10B schematically illustrate an example of the zone replacement. FIG. 10A is a diagram schematically illustrating a state before the zone replacement, and FIG. 10B is a diagram schematically illustrating a state after the zone replacement. In the example illustrated in FIG. 10A, an identifier (corresponding to a physical address) of 000 to 011 is assigned to the head zone of a head 25x from the outer side to the inner side. An identifier (corresponding to a physical address) of each of 100 to 111 is assigned to the head zone of the head 25y from the outer side to the inner side. Among these head zones, the head zones with identifiers 000 to 003 and the head zones with identifiers 100 to 103 are MAMR function OFF areas S2x and S2y. In contrast, the head zones with identifiers 004 to 011 and the head zones with identifiers 104 to 111 are MAMR function ON areas Six and Sly. Data has been already written in these head zones, and unique logical addresses are respectively allocated to these head zones. Of these, the head zone of the identifier 007 of the head 25x (hereinafter referred to as “head zone 007”) has the largest amount of writing, and a head zone of the identifier 101 of the head 25y (hereinafter referred to as “head zone 101”) has the smallest write amount.

Therefore, in the address table after the zone replacement, as illustrated in FIG. 10B, the logical addresses E0000h to EFFFFh (see FIG. 10A) allocated to the head zone 007 of the head 25x are replaced with the logical addresses 3000h to 3FFFFh (see FIG. 10A) allocated to the head zone 101 of the head 25y. Similarly, logical addresses 3000h to 3FFFFh (see FIG. 10A) allocated to the head zone 101 are replaced with logical addresses E0000h to EFFFFh (see FIG. 10A) allocated to the head zone 007. Note that the zone replacement is not limited to between different disks 21, and may be performed within the same disk 21.

In contrast, as illustrated in FIG. 9, when there is an unused area in S403, the R/W control unit 811 performs the zone movement for a head zone (hereinafter referred to as “movement source zone”) in which the write amount in the assisted recording is equal to or greater than the reference write amount (has reached the reference write amount) (S406). For example, the R/W control unit 811 selects a head zone (hereinafter referred to as “movement destination zone”) in which the write amount of data recorded by the head 25 via the non-assisted recording within a predetermined time is zero. Then, the movement source zone is moved to the MAMR function OFF area, and the selected movement destination zone is moved to the MAMR function ON area, respectively. Specifically, the R/W control unit 811 reallocates the logical address of the movement source zone to the logical address of the movement destination zone in the address table, and updates the table information. Accordingly, the logical address allocated to the physical address of the movement source zone is newly allocated as a logical address corresponding to the physical address of the movement destination zone. Further, the logical address allocated to the physical address of the movement source zone is deleted. Therefore, the write data of the movement source zone is moved from the MAMR function ON area to the MAMR function OFF area on the logical address. Write data is not recorded in the movement destination zone before the zone movement. In other words, the movement destination zone before zone movement is an unused area to which no logical address is allocated. Further, the movement source zone after the zone movement is an unused area to which no logical address is allocated.

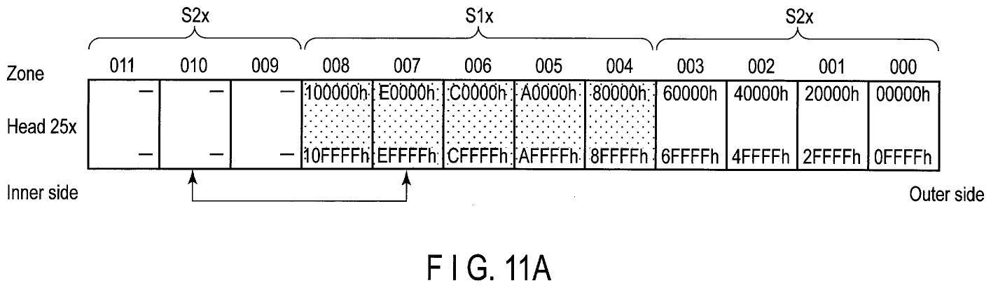

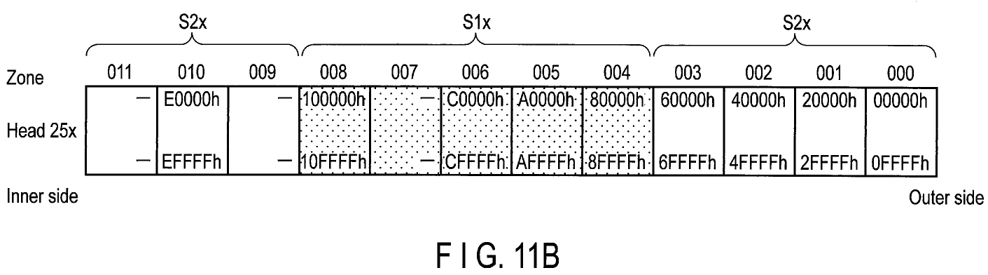

FIGS. 11A and 11B schematically illustrate an example of the zone movement. FIG. 11A is a diagram schematically illustrating a state before the zone movement, and FIG. 11B is a diagram schematically illustrating a state after the zone movement. In the example illustrated in FIG. 11A, identifiers 000 to 011 (corresponding to physical addresses) are assigned from the outer side to the inner side of the head zone of the head 25x. Among these identifiers, the head zones of the identifiers 000 to 003 and 009 to 011 are the MAMR function OFF area S2x. In contrast, the head zones of the identifiers 004 to 008 are the MAMR function ON area Six. Among these head zones, a unique logical address is allocated to each head zone in which data is written. Among these, the head zone of the identifier 007 of the head 25x (hereinafter referred to as “head zone 007”) has the largest write amount, and the head zones of the identifiers 009 to 011 (hereinafter, referred to as “head zones 009 to 011”) are free areas (unused areas) where no data is written. Therefore, in the address table after zone movement, as illustrated in FIG. 11B, the logical addresses E0000h to EFFFFh (see FIG. 11A) allocated to the head zone 007 of the head 25x are deleted and are allocated to the head zone 010. Note that an allocation destination may be the head zone 009 or the head zone 011 instead of the head zone 010. Further, the zone movement is not limited to within the same disk 21, and may be performed between different disks 21.

Note that, after detecting the write amount in S401, if the write amount of the head 25 gets closer to (is approaching) the head lifetime, the assisted recording conditions may be determined for each head zone of the disk 21 corresponding to the head 25. At this time, for example, based on the head lifetime, the head zone in the MAMR function ON area of the disk 21 may be replaced with or moved to the head zone in the MAMR function OFF area.

In addition, in the head 25 in which the write amount of the write data has approached the head lifetime, non-assisted recording may be executed and the write data may be written to the disk 21 in a mode with verification. Whether or not the write amount of the write data has approached the head lifetime is determined based on, for example, whether or not the write amount has reached the reference write amount. In the write mode with verification, after the data is written, the write data is read to confirm data contents. Accordingly, the situation where the write data is not properly written can be suppressed, and the reliability of the write data can be improved.

As described above, according to the HDD 1 of the embodiment, when data is written on the disk 21, it is possible to appropriately switch the mode of control between the control to execute the assisted recording and the control not to execute the assisted recording. Accordingly, the MAMR function ON area and the MAMR function OFF area can be mixedly provided on the recording surface of one disk 21. It is also possible to provide the MAMR function ON area and the MAMR function OFF area mixedly on each recording surface of a plurality of disks 21, or to use only one of the MAMR function ON area and the MAMR function OFF area.

When executing the assisted recording, the MPU 81 applies an assist voltage to the spin torque oscillator WH5 to cause the write head WH to write data. In contrast, when the assisted recording is not executed and the non-assisted recording is executed, the MPU 81 causes the write head WH to write data without applying an assist voltage to the spin torque oscillator WH5. Therefore, by appropriately switching control from the control to execute the assisted recording to the control not to execute the assisted recording, it is possible to reduce the application time of the assist voltage to the spin torque oscillator WH5. For this reason, the element lifetime of the spin torque oscillator WH5 can be improved, and deterioration in quality due to the decrease in element lifetime can be suppressed. Accordingly, the quality of the HDD 1 as a device can be maintained for a long time. Accordingly, for example, the degree of freedom of giving priority to the disk capacity of the HDD 1 or the lifetime of the apparatus is increased, and it becomes easier to meet the needs of various customers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk;
a head comprising a magnetic flux control unit configured to generate a magnetic field toward the magnetic disk;
a control circuit configured to apply a drive voltage that generates the magnetic field to the magnetic flux control unit; and
a controller configured to control the head and the control circuit, respectively, wherein
the controller determines whether or not to cause the magnetic flux control unit to generate a magnetic field, and in accordance with the determination result, causes the control circuit to apply a drive voltage to the magnetic flux control unit so that an assisted recording area and a non-assisted recording area are provided in the magnetic disk mixedly as desired, the assisted recording area being an area of the magnetic disk in which data is written while a magnetic field is generated, and the non-assisted recording area being an area of the magnetic disk in which data is written while a magnetic field is not generated.

2. The magnetic disk device according to claim 1, wherein
the controller determines the condition based on a lifetime of the head, and causes the control circuit to apply the drive voltage to the magnetic flux control unit so that the non-assisted recording area increases with a decrease in the lifetime of the head.

3. The magnetic disk device according to claim 1, wherein
the controller determines the condition based on a lifetime of the head, and when the lifetime has reached a predetermined threshold value, the controller does not cause the control circuit to apply the drive voltage to the magnetic flux control unit, and when the lifetime has not reached the predetermined threshold value, the controller causes the control circuit to apply the drive voltage to the magnetic flux control unit.

4. The magnetic disk device according to claim 1, wherein
the magnetic disk comprises a cache area where a frequency of writing the data is higher than that of other recording areas and, the controller causes the control circuit to write the data to the cache area without applying the drive voltage to the magnetic flux control unit.

5. The magnetic disk device according to claim 1, wherein
the controller determines the condition based on a writing amount of the data for each zone including one or a plurality of disk tracks on which the head writes the data.

6. The magnetic disk device according to claim 5, wherein
the controller includes a table configured to define a physical address assigned to the zone, a logical address uniquely allocated to the physical address, a correspondence indicating whether the zone is the assisted recording area or the non-assisted recording area, and updates information in the table by replacing the logical address allocated to the assisted recording area with the logical address allocated to the non-assisted recording area based on the writing amount.

7. The magnetic disk device according to claim 5, wherein
the controller includes a table configured to define a physical address assigned to the zone, a logical address uniquely allocated to the physical address, a correspondence indicating whether the zone is the assisted recording area or the non-assisted recording area, and updates information in the table by reallocating the logical address allocated to the assisted recording area to an unused non-assisted recording area based on the writing amount.

8. The magnetic disk device according to claim 6, wherein
the controller causes the data to be written in a mode with verification when the writing amount reaches a predetermined threshold value.

9. The magnetic disk device according to claim 7, wherein
the controller causes the data to be written in a mode with verification when the writing amount reaches a predetermined threshold value.

10. A method of controlling a magnetic disk device, comprising:
determining whether to assist writing of data to a magnetic disk by generating a magnetic field from a head toward the magnetic disk; and
in accordance with the determination result, causing the head to generate the magnetic field so that an assisted recording area and a non-assisted recording area are provided in the magnetic disk mixedly as desired, the assisted recording area being an area where the data is written in an assisted manner, and the non-assisted recording area being an area where the data is written in a non-assisted manner.
